(19) United States
(12) Patent Application Publication
(10) Pub. No.: US 2008/0008364 A1
(43) Pub. Date: Jan. 10, 2008

(54) VIDEO MONITORING DEVICE FOR VEHICLE

(76) Inventors: Teng-Tsai Huang, Taichung (TW); Yu-Lin Chiang, Jhonghe City (TW)

Correspondence Address: LEONG C LEI, PMB # 1008, 1867 YGNACIO VALLEY ROAD, WALNUT CREEK, CA, 94598, US

(21) Appl. No.: 11/456,217

(22) Filed: Jul. 10, 2006

(51) Int. Cl. G06T 7/20

(52) U.S. Cl. 382/120

(57) ABSTRACT

A video monitoring device for vehicles contains a plurality of cameras, a digital image processing unit, and a display device. The cameras are installed at the bottom rims of the sideview mirrors, and/or the front and back rims of the vehicle. The images captured by the camera are combined and processed by the digital image processing unit for presentation on the display device. The digital image processing unit contains a moving object highlight unit to frame and trace the images of moving objects in the image presented on the display device.

### BACKGROUND OF THE INVENTION

(a) Technical Field of the Invention

The present invention generally relates to video monitoring devices used on vehicles, and more particularly to a vehicle-mounted video monitoring device capable of accentuating moving objects.

(b) Description of the Prior Art

Almost all of today's automobiles have sideview mirrors installed at the sides of the automobile body so that that driver is informed of events happening behind the automobile when driving forward or backing up. These conventional sideview mirrors have limited viewing angles and some blind spots are inevitable. On the other hand, when back up, the driver usually has to turn his or her head to gain a better view, which is not convenient and unsafe as well. Even though some of the more advanced automobiles have video cameras installed at the rear end of the automobile and the captured images are presented on a display device on the dash board, these video cameras do not provide highlight to objects moving around the rear end of the automobile.

### SUMMARY OF THE INVENTION

The primary purpose of the present invention is to provide a video monitoring device for vehicles so that activities happening around the vehicle during driving or backing up can be monitored and, especially, the moving objects are highlighted, so as to enhance the safety of driving.

The video monitoring device contains a plurality of cameras, a digital image processing unit, and a display device. The cameras are installed at the bottom rims of the sideview mirrors, and/or the front and back rims of the vehicle. As such, the images captured by the cameras cover the largest possible surrounding of the vehicle and the images are then processed by the digital images processing unit for presentation on the display device. The driver is therefore fully aware of what happens around the vehicle, regardless of whether the vehicle is moving forward or backward.

The digital imaging processing unit of the video monitoring device contains a moving object highlight unit to frame and trace the images of moving objects in the image presented on the display device. The driver is therefore is specifically alerted about the objects that are shifting places around the vehicle.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top view of a vehicle having the video monitoring device according to an embodiment of the present invention installed.

FIG. 2 is a schematic view of a sideview mirror having the camera of the present invention installed on the bottom rim.

FIG. 3 is a schematic diagram showing the various components of the present invention.

FIG. 4 is a schematic diagram showing the coverage of the video monitoring device of FIG. 1.

FIG. 5 is a schematic diagram showing how a moving object is framed by the moving object highlight unit of the present invention.

FIG. 6 is a schematic diagram showing the coverage of the video monitoring device according to another embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

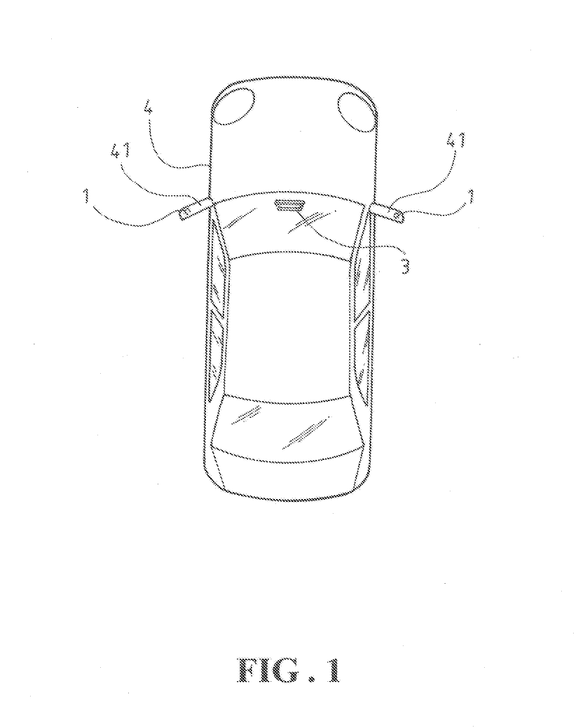

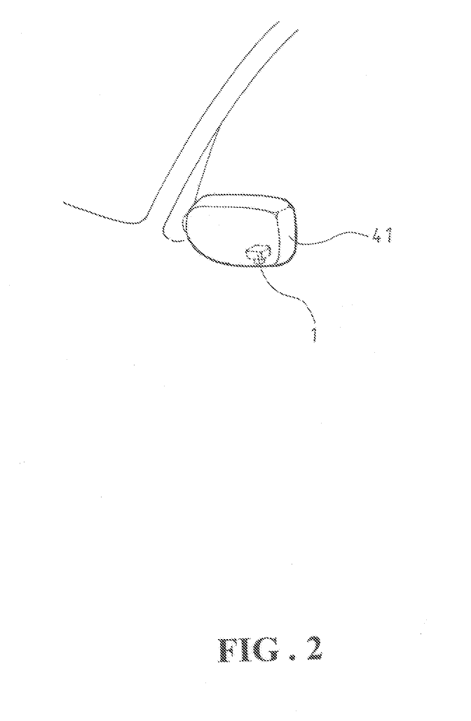

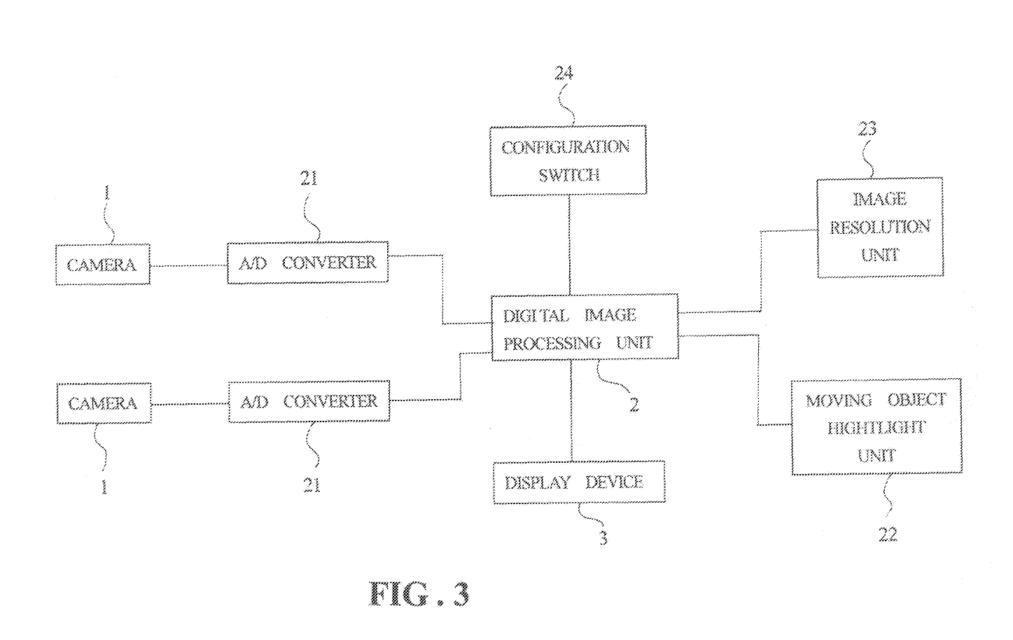

As illustrated in FIGS. 1, 2, and 3, the video monitoring device according to an embodiment of the present invention contains a plurality of cameras 1, a digital image processing unit 2, and a display device 3 connected to the digital image processing unit 2 and positioned inside a vehicle in front of the driver seat. The cameras 1 are installed in the sideview mirrors 41 respectively. In a preferred embodiment, the cameras 1 are positioned on the bottom rims of the sideview mirrors 41 so as to jointly achieve the largest degree of coverage (over 180 degrees) of the surrounding of the vehicle.

Each of the cameras 1 is connected to an analog-to-digital (A/D) converter 21 which in turn is connected to the digital image processing unit 2. The digital image processing unit is then connected to the display device 3. The digital image processing unit 2 contains a moving object highlight unit 22 and an image resolution unit 23. The image resolution unit 23 combines and process the images captured by the cameras 1 so that they can be jointly presented on the display device 3 as a planar image. For objects moving in the coverage of the cameras 1, their images are framed by a rectangular box in the presented planar image by the moving object highlight unit 22. The function of highlighting moving objects is controlled (e.g., turned on and off) by the configuration switch 24.

Please note that the cameras 2 jointly provide a viewing angle over 180 degrees. The images captured by the cameras 1, if not processed by the image resolution unit 23 and presented directly on the display device 3, would be skewed and cannot provide clear observation.

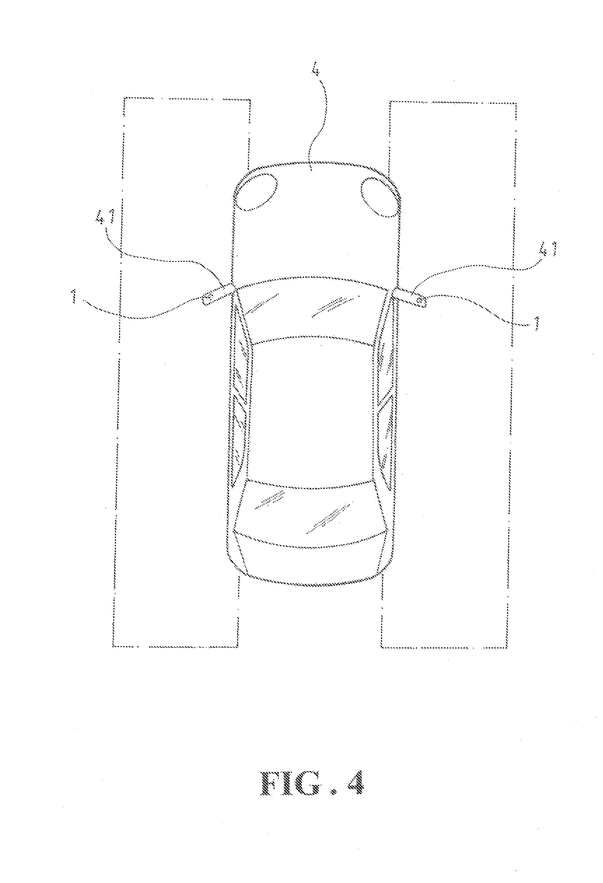

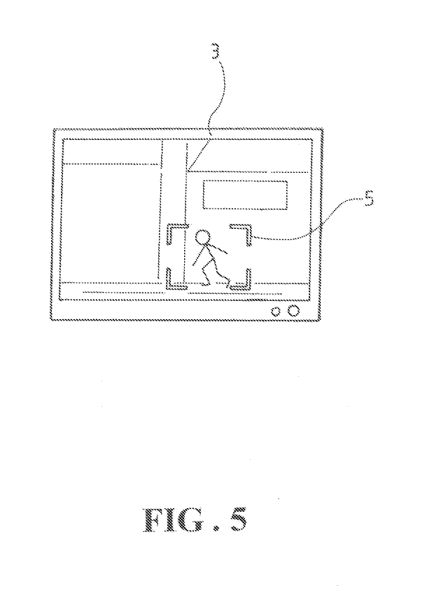

As shown in FIG. 4, the cameras 1 covers the complete areas along the two sides of the vehicle and the images of the two areas are combined and presented on the display device 3. A driver is therefore well aware of what is happening around the vehicle. As shown in FIG. 5, the moving object highlight unit 22 frames the image of a moving object by a rectangular box 5 in the image presented on the display device 3 and the rectangular box 5 would trace the movement of the object. As such, the driver is alerted about the objects that are shifting places around the vehicle.

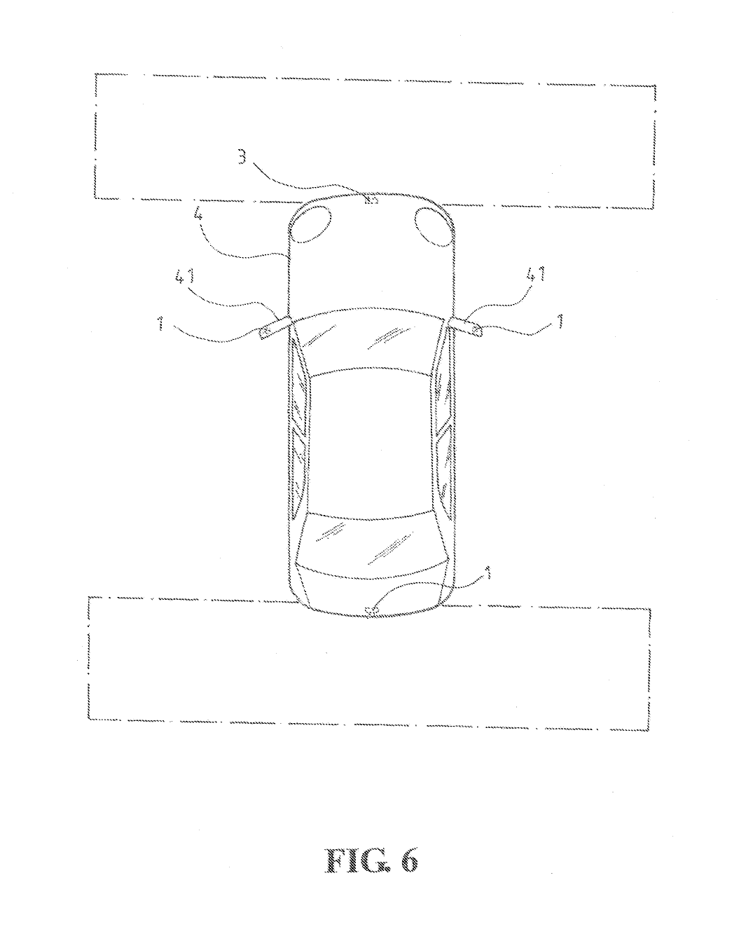

As shown in FIG. 6, the cameras 1 can also be installed on the front and back rims of the vehicle to cover and monitor the front and back areas of the vehicle. The foregoing moving object highlight function is also provided in the present embodiment to enhance the safety of driving and backing up the vehicle.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A video monitoring device of a vehicle, comprising:
a plurality of cameras positioned at appropriate locations along the body of said vehicle for capturing images around said vehicle;
a display device inside said vehicle; and
a digital image processing unit connected to said cameras and said display device, said digital image processing unit having an image resolution unit and a moving object highlight unit, said image resolution unit combining the images captured by said cameras into a planar image and presenting said planar image on said display device, said moving object highlight unit framing and tracing the image of a moving object within the coverage of said cameras in said planar image.

2. The video monitoring device according to claim 1, wherein said cameras are installed on the bottom rims of the sideview mirrors of said vehicle respectively.

3. The video monitoring device according to claim 1, wherein said cameras are installed on the front and back rims of said vehicle respectively.
